(19) United States
(12) Patent Application Publication
(10) Pub. No.: US 2016/0111010 A1
(43) Pub. Date: Apr. 21, 2016

(54) INFORMATION SEARCH/PRESENTATION DEVICE AND INFORMATION SEARCH/PRESENTATION METHOD

(71) Applicant: Hitachi, Ltd., Tokyo (JP)

(72) Inventors: Tetsuro ADACHI, Tokyo (JP); Kentaro TAGUCHI, Tokyo (JP); Takahisa OOMIYA, Tokyo (JP); Shigeru SASAKI, Tokyo (JP)

(73) Assignee: HITACHI, LTD., Tokyo (JP)

(21) Appl. No.: 14/632,597

(22) Filed: Feb. 26, 2015

(30) Foreign Application Priority Data
Oct. 21, 2014 (JP) 2014-214159

(51) Int. Cl. G09B 7/00

(52) U.S. Cl. CPC G09B 7/00

(57) ABSTRACT

Provided is a technology capable of appropriately presenting an answer in accordance with an attribute of a user such as an operating environment. An information search/presentation device includes: an operation information acquisition unit configured to acquire a question transmitted from a terminal; a storage unit configured to store an answer candidate to the question and user attribute information on a user of the terminal to which the answer candidate is expected to be transmitted; an answer extraction unit configured to calculate a similarity for each answer candidate associated in the storage unit with the question acquired by the operation information acquisition unit, and extract an answer from the answer candidate by using the similarity; and an output unit configured to output the extracted answer to the terminal. The answer extraction unit identifies the user attribute information on the user who has transmitted the question, and calculates the similarity between the identified user attribute information and the user attribute information associated with the answer candidate in the storage unit.

### BACKGROUND OF THE INVENTION

The present invention relates to an information search/presentation device and an information search/presentation method. The present invention claims priority to Japanese Patent Application No. 2014-214159 filed on Oct. 21, 2014, the contents of which are incorporated herein by reference in its entirety for the designated states where incorporation by reference of literature is allowed.

There is disclosed a technology which causes an information processing device to present an answer to a question of use of a computer when an input of the question is received.

Japanese Patent Laid-open Publication No. 2013-54490 discloses a technology regarding an information search device “including a control unit configured to receive inquiry information from a user receiving a service via a network and read past inquiry history information and system operation history information on the user; an arithmetic unit configured to extract inquiry candidates similar to an inquiry made at the current time from the past inquiry history information and compare a system operation history obtained before the inquiry is made by the user with a system operation history of a user corresponding to each record of the similar inquiry candidates to determine a similarity of event sequences; and an output processing unit configured to output the past specific answers of the similar inquiry candidates in descending order of the similarity as a recommended measure plan”.

When the information processing device such as a server device receives the question input through a terminal device operated by the user and presents a solution to the terminal device, the solution may differ depending on a use environment on the terminal device, the user's use authority, or the like.

In the technology disclosed in Japanese Patent Laid-open Publication No. 2013-54490, the specific answer is presented based on an operation history of the terminal device. Therefore, even when the question is input from the terminal devices different in an attribute on the terminal device or an attribute on the user, in a case where the operation history is common, the same answer is presented. This answer may not be suitable for the attribute on the user operating the terminal device or an operating situation of the terminal device.

### SUMMARY OF THE INVENTION

The present invention has been made in view of the above-mentioned issue, and an object thereof is to provide a technology capable of appropriately presenting an answer in accordance with an attribute of a user such as an operating environment.

The present application includes a plurality of measures for solving the above-mentioned problem, examples of which are enumerated as follows.

In order to solve the above-mentioned problem, according to one embodiment of the present invention, there is provided an information search/presentation device, including: an operation information acquisition unit configured to acquire a question transmitted from a terminal; a storage unit configured to store an answer candidate to the question and user attribute information on a user of the terminal to which the answer candidate is expected to be transmitted; an answer extraction unit configured to calculate a similarity for each answer candidate associated in the storage unit with the question acquired by the operation information acquisition unit, and extract an answer from the answer candidate by using the similarity; and an output unit configured to output the extracted answer to the terminal, in which the answer extraction unit identifies the user attribute information on the user who has transmitted the question, and calculates the similarity between the identified user attribute information and the user attribute information associated with the answer candidate in the storage unit.

According to the one embodiment of the present invention, it is possible to appropriately present an answer in accordance with an attribute of a user such as an operating environment.

Objects, configurations, and effects other than those described above become apparent by descriptions of the following embodiments.

### BRIEF DESCRIPTION OF THE DRAWINGS

FIG. 1 is a diagram illustrating an example of functional blocks of an information search/presentation device according to a first embodiment of the present invention.

FIG. 2 is a diagram illustrating a hardware configuration example of the information search/presentation device.

FIG. 3 is a table showing an example of question-specific event log information.

FIG. 4 is a table showing an example of FAQ master information.

FIG. 5 is a table showing an example of user information.

FIG. 6 is a table showing an example of answer-specific attribute information.

FIG. 7 is a table showing an example of event log information.

FIG. 8 is a table showing an example of event similarity information.

FIG. 9 is a table showing an example of attribute similarity information.

FIG. 10 is a flowchart illustrating a flow of question candidate extraction processing.

FIG. 11 is a flowchart illustrating a flow of answer extraction processing.

FIG. 12 is a diagram illustrating an example of an application screen including a question candidate display area.

FIG. 13 is a diagram illustrating an example of an application screen including an answer display area.

FIG. 14 is a diagram illustrating an example of functional blocks of an information search/presentation device according to a second embodiment of the present invention.

### DESCRIPTION OF THE PREFERRED EMBODIMENTS

### First Embodiment

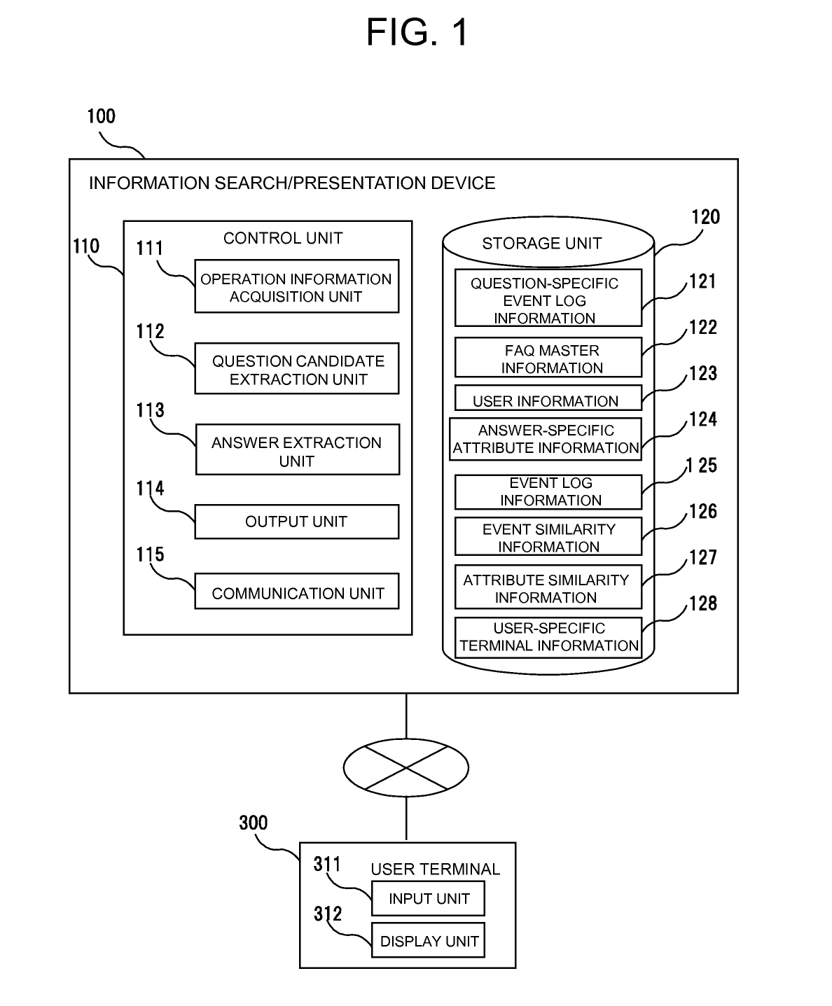

Now, a description is made of examples of an embodiment of the present invention with reference to the accompanying drawings. FIG. 1 is a diagram illustrating an example of functional blocks of an information search/presentation device 100 according to a first embodiment of the present invention. The information search/presentation device 100 is an electronic device such as a server or a personal computer (PC). The information search/presentation device 100 according to this embodiment serves as a data center in a thin client solution expanded on the service of cloud computing.

A network 50 is a communication network such as a local area network (LAN) which is managed by an organization to which a user belongs. Note that, the network 50 may be a communication network which uses, as a part or an entirety thereof, a public communication network such as the Internet, a wide area network (WAN), or a general public line such as a virtual private network (VPN).

A user terminal 300 is an electronic device such as a PC, which can be connected to the information search/presentation device 100 via the network 50. The user terminal 300 may be a mobile device such as a tablet terminal. The user terminal 300 according to this embodiment functions as a thin client terminal by transmitting information which identifies the user (and information relating thereto) to the information search/presentation device 100.

Note that, when operated by a user A, a predetermined user terminal 300 transmits the information which identifies the user A to the information search/presentation device 100, and operates under an operating environment given to the user A. In the same manner, when operated by a user B, the predetermined user terminal 300 transmits the information which identifies the user B to the information search/presentation device 100, and operates under an operating environment given to the user B.

FIG. 1 illustrates a state in which, for the sake of convenience, one user terminal 300 is connected to one information search/presentation device 100, but this embodiment is not limited thereto.

The information search/presentation device 100 includes a control unit 110 and a storage unit 120.

The control unit 110 according to this embodiment controls processing for providing the user terminal 300 with a desktop environment. Further, the control unit 110 controls display of question candidates on the user terminal 300, extraction of an answer, display of the extracted answer, and the like. The storage unit 120 stores information necessary for the processing of the control unit 110.

The control unit 110 includes an operation information acquisition unit 111, a question candidate extraction unit 112, an answer extraction unit 113, an output unit 114, and a communication unit 115.

The operation information acquisition unit 111 acquires operation information serving as information relating to an operation carried out for the user terminal 300 via the communication unit 115. The operation information represents an execution instruction or input processing performed on a screen by the user. An application usedby the user includes, as a graphical user interface (GUI), objects such as an input box for receiving an input of text or the like from the user, a selectable list box, a radio button, and an execute button. Further, information indicating a unique identifier and a function name is defined in each object, and the operation information acquisition unit 111 can acquire the operation information in which an input action is identified.

For example, the operation information acquisition unit 111 acquires information which identifies the question selected from the question candidates displayed on the user terminal 300 from the user terminal 300 via the communication unit 115. Further, the operation information acquisition unit 111 stores the acquired operation information in the storage unit 120. The operation information is stored in the event log information as an operation history.

The question candidate extraction unit 112 uses the operation information acquired by the operation information acquisition unit 111 and question-specific event log information stored in the storage unit 120 to extract the question candidates to be displayed on the user terminal 300. The question candidate extraction unit 112 extracts questions to be candidates by calculating, for each question, a similarity between the operation history acquired by the operation information acquisition unit 111 and the operation history stored in the question-specific event log information. Details thereof are described later.

The answer extraction unit 113 identifies user attribute information on the user relating to the user terminal 300 that has selected the question from the question candidates. Further, the answer extraction unit 113 narrows down answer candidates regarding the question selected on the user terminal 300, and calculates the similarity for each of the answer candidates. The answer extraction unit 113 extracts the answer candidate having a high similarity as an answer suitable to be transmitted to the user terminal 300. The calculation of the similarity is described later.

The output unit 114 generates display information to be displayed on a display unit of the user terminal 300, and outputs the display information to the user terminal 300 via the communication unit 115. The output unit 114 generates the display information for displaying an application screen having, for example, a question candidate display area for displaying the question candidates extracted by the question candidate extraction unit 112 and an answer display area for displaying the answer extracted by the answer extraction unit 113, and transmits the display information to the user terminal 300 via the communication unit 115.

The communication unit 115 intermediates transmission/reception of the information to/from the user terminal 300 in the information search/presentation device 100. The communication unit 115 receives the operation information from the user terminal 300. Further, the communication unit 115 transmits the display information generated by the output unit 114 to the user terminal 300.

The storage unit 120 stores question-specific event log information 121, frequently asked questions (FAQ) master information 122, user information 123, answer-specific attribute information 124, event log information 125, event similarity information 126, attribute similarity information 127, and user-specific terminal information 128. The question-specific event log information 121, the FAQ master information 122, the user information 123, and the answer-specific attribute information 124 are information stored in advance in the storage unit 120 before processing described in this embodiment starts.

The question-specific event log information 121 is information obtained by associating the question expected to be posed by the user terminal 300 with the operation history of an operation expected to be operated by a time of an occurrence of the question on the user terminal 300 that transmits the question. When a predetermined input operation is carried out on the user terminal 300, the questions to be asked may be narrowed down to some extent based on the operation history of the input operation. In the question-specific event log information 121, the operation history is associated with the question expected to be posed by the user terminal 300 including the operation history.

The FAQ master information 122 is information obtained by associating the question with the answer. In the FAQ master information 122, the question that is stored in the question-specific event log information 121 is associated with at least one answer candidate to be the answer.

The user information 123 is information relating to an attribute of the user who operates the user terminal 300. The user information 123 includes the user attribute information serving as information relating to, for example, an administrative authority of the user and the operating environment of the user terminal 300 given to the user.

The answer-specific attribute information 124 is information obtained by associating the answer with the user attribute information on the user to which the answer is expected to be transmitted. The answer to be transmitted to the user terminal 300 is extracted based on the user attribute information within the answer-specific attribute information 124 and the user attribute information on the user who has transmitted the question.

The event log information 125 is information which stores the operation information transmitted from the user terminal 300 as the operation history in received order. The event log information 125 is generated for each user when there exist a plurality of users who operate the user terminal 300 connected to the information search/presentation device 100.

The event similarity information 126 is information obtained by associating the question whose similarity is calculated by the question candidate extraction unit 112 with the calculated similarity.

The attribute similarity information 127 is information obtained by associating the answer candidate whose similarity is calculated by the answer extraction unit 113 with the calculated similarity.

The user-specific terminal information 128 is information relating to a program for operating the user terminal 300 under the operating environment given to each user. For example, the user-specific terminal information 128 includes the program for driving software or an operating system (OS) given to the user.

The user terminal 300 includes an input unit 311 and a display unit 312.

The input unit 311 identifies the operation information input by the user via an input device described later. The input unit 311 transmits the identified operation information to the information search/presentation device 100. The display unit 312 displays the screen on a display device described later by using the display information generated by the output unit 114 of the information search/presentation device 100.

Hitherto, there exists a technology in which the answer to the question is uniquely obtained based on the operation history. However, in general, the answer to the question is not always determined uniquely even with the same operation history. For example, assuming that an authentication error occurs at a time of system login because the user remembers an erroneous password, it is conceivable that the user asks a question as to how to reissue the password for login. In this case, it may be suitable to present the answer such as “Reset your password by yourself” to the user who has the administrative authority for the system while presenting the answer such as “Ask your administrator to reissue your password” to a general user who does not have the administrative authority. In this embodiment, the answer is extracted based on the user attribute information on the user who has transmitted the question, and hence it is possible to provide the user terminal 300 with the answer corresponding to the attribute information on the user.

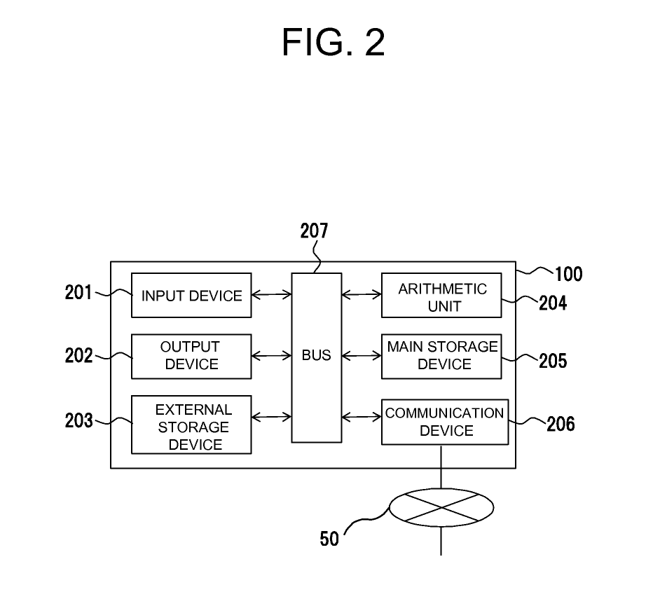

FIG. 2 is a diagram illustrating a hardware configuration example of the information search/presentation device 100. The information search/presentation device 100 includes an input device 201, an output device 202, an external storage device 203, an arithmetic unit 204, a main storage device 205, and a communication device 206, and the respective components are connected to one another through a bus 207.

The input device 201 is a device for receiving an input from a person who operates the information search/presentation device 100. The input device 201 is, for example, a keyboard, a mouse, a touch panel, a stylus, or other such pointing devices.

The output device 202 is, for example, a display device such as a display. Alternatively, the output device 202 may be a sound output device such as a speaker.

The external storage device 203 is, for example, anon-volatile memory that is writable and readable such as a hard disk drive or a flash memory.

The arithmetic unit 204 is a central processing unit (CPU), and executes processing in accordance with a program recorded in the main storage device 205 or the external storage device 203. Each processing unit that forms the control unit 110 implements each function by the arithmetic unit 204 executing the program.

The main storage device 205 is a storage device such as a random access memory (RAM), and functions as a storage area into which the program and data are temporarily read.

The communication device 206 is a wireless communication device for conducting wireless communications through an antenna or a wired communication device for conducting wired communications through a network cable.

The function of the storage unit 120 is implemented by the external storage device 203 or the main storage device 205. Further, the function of the storage unit 120 may be implemented by another storage device on the network 50.

Note that, the processing of each component of the information search/presentation device 100 may be executed by one piece of hardware or may be executed by a plurality of pieces of hardware. Further, the processing of each component of the information search/presentation device 100 may be implemented by one program or may be implemented by a plurality of programs.

Further, the user terminal 300 has the same hardware configuration as the information search/presentation device 100, and hence a description of the hardware configuration of the user terminal 300 is omitted.

Next, a description is made of each piece of information stored in the storage unit 120.

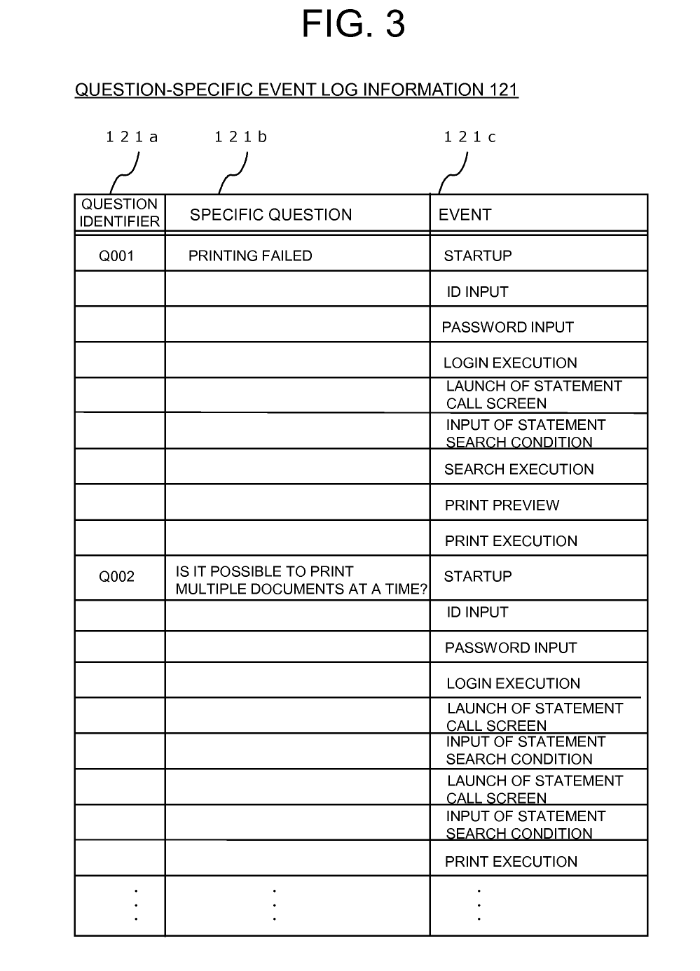

FIG. 3 is a table showing an example of the question-specific event log information 121. The question-specific event log information 121 is information obtained by associating the question with the operation history based on which the question is expected to be posed.

The question-specific event log information 121 includes a question identifier 121a, a specific question 121b, and an event 121c. The question identifier 121a is an identifier which identifies the question expected to be input on the user terminal 300.

The specific question 121b is information indicating a specific question which is expected. The event 121c is an operation history in which pieces of operation information expected to be input by the time of the occurrence of the question on the user terminal 300 are listed in input order when the question relating to the specific question 121b is assumed. In the question-specific event log information 121, one question identifier 121a is associated with at least one event 121c.

In FIG. 3, the question identifier 121a of “Q001” is associated with the specific question 121b of “Printing failed” and the events 121c of “startup”, “ID input”, “password input”, “login execution”, “launch of statement call screen”, “input of statement search condition”, “search execution”, “print preview”, and “print execution” in the stated order. This indicates that the question relating to the specific question 121b of “Printing failed” is expected to be asked when the pieces of operation information including “startup”, “ID input”, “password input”, “login execution”, “launch of statement call screen”, “input of statement search condition”, “search execution”, “print preview”, and “print execution” are input on the user terminal 300 in the stated order.

Note that, the question candidate to be displayed on the user terminal 300 is determined by comparing the event 121c stored in the question-specific event log information 121 with the operation history obtained by accumulating the pieces of operation information input by the user terminal 300. Therefore, it is desired that, in the question-specific event log information 121, the question identifier 121a be associated with the event 121c in units that can be compared with the operation history. For example, the pieces of operation information that are carried out after the startup of the user terminal 300 or the selection of the execute button on the user terminal 300 until the execute button is selected next are associated with one question identifier. 121a in operating order.

Note that, the question-specific event log information 121 may be generated based on an empirical rule. For example, the question-specific event log information 121 may be information obtained by associating the question received in the past with the operation history input on the user terminal 300 when the question is received.

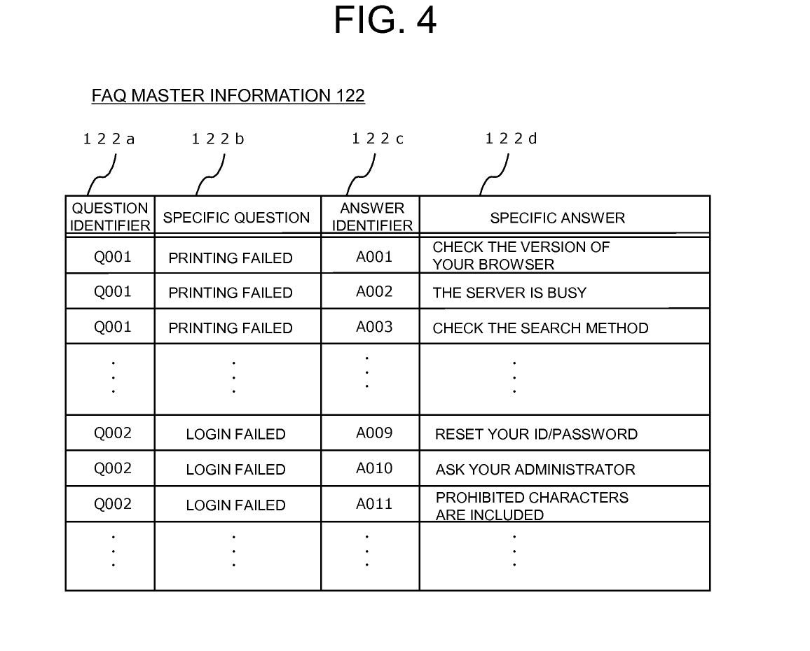

FIG. 4 is a table showing an example of the FAQ master information 122. The FAQ master information 122 is associated with a question identifier 122a, a specific question 122b, an answer identifier 122c, and a specific answer 122d.

The question identifier 122a is an identifier which identifies the question expected to be posed by the user device, and corresponds to the question identifier 121a of the question-specific event log information 121. The specific question 122b is information indicating the specific question.

The answer identifier 122c is an identifier which identifies the answer candidate expected for the question. The specific answer 122d is information indicating a specific answer candidate. In the FAQ master information 122, at least one answer identifier 122c is associated with one question identifier 122a.

For example, in the FAQ master information 122 of FIG. 4, the question having the question identifier 122a of “Q001” and the specific question 122b of “Printing failed” is associated with three answers. Specifically, this question is associated with the answer candidate having the answer identifier 122c of “A001” and the specific answer 122d of “Check the version of your browser”, the answer candidate having the answer identifier 122c of “A002” and the specific answer 122d of “The server is busy”, and the answer candidate having the answer identifier 122c of “A003” and the specific answer 122d of “Check the search method”. This indicates that three answer candidates are expected for the question.

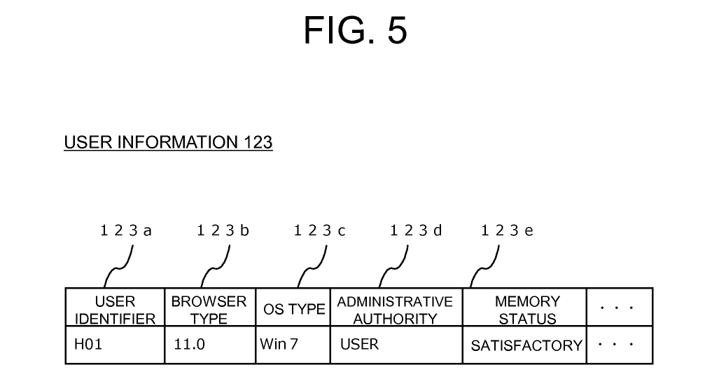

FIG. 5 is a table showing an example of the user information 123. In the user information 123 shown in FIG. 5, a user identifier 123a is associated with a browser type 123b, an OS type 123c, an administrative authority 123d, and a memory status 123e as the user attribute information. The following description is made by assuming that, of the pieces of information included in the user information 123, each of the pieces of information except the user identifier 123a is an item of the user attribute information.

The user identifier 123a is identification information which identifies the user. The browser type 123b is information indicating the type of browser given to the user. “11.0” in the browser type 123b shown in FIG. 5 is a value indicating the version of the browser given to the user having the user identifier 123a of “H01”, but the browser type 123b is not limited to the version of the browser.

The OS type 123c is information indicating the type of OS given to the user. In the same manner as the browser type 123b, the OS type 123c is not limited to the description of FIG. 5, and may be information indicating a name of the OS or may be information indicating the version.

The administrative authority 123d is information indicating the administrative authority owned by the user. The administrative authority 123d shown in FIG. 5 is “USER”, which indicates that the user having the user identifier 123a of “H01” does not have the administrative authority. Note that, in the case of the user having the administrative authority, the administrative authority 123d is set to “ADMIN”.

The memory status 123e is information which identifies a use status of the memory on the hardware of the user terminal 300. The memory status 123e shown in FIG. 5 is “satisfactory”, which indicates that the use status of the memory usable by the user terminal 300 used by the user having the user identifier 123a of “H01” is satisfactory. Note that, for example, the memory status 123e may be information updated periodically by the control unit 110 of the information search/presentation device 100. Further, the memory status 123e may be a relative or absolute numerical value indicating a usage amount of the memory on the user terminal 300.

Note that, the information included in the user information 123 is not limited to the above-mentioned information. For example, information which identifies a department to which the user belongs, information on a duty position used as a reference of an authorization procedure, the user's physical location, a load on an arithmetic unit 204 of the information search/presentation device 100 that provides the application, or a congested state of a network line may be included.

The answer to be presented to the user is extracted based on the user attribute information included in the user information 123, and hence it is desired that the user attribute information serving as an appropriate branch condition for extracting an appropriate answer be included in the user information 123. Describing by use of the above-mentioned example, when the answer to be transmitted differs depending on the administrative authority of the user, the administrative authority 123d serving as the user attribute information becomes the branch condition which leads to appropriate answer extraction.

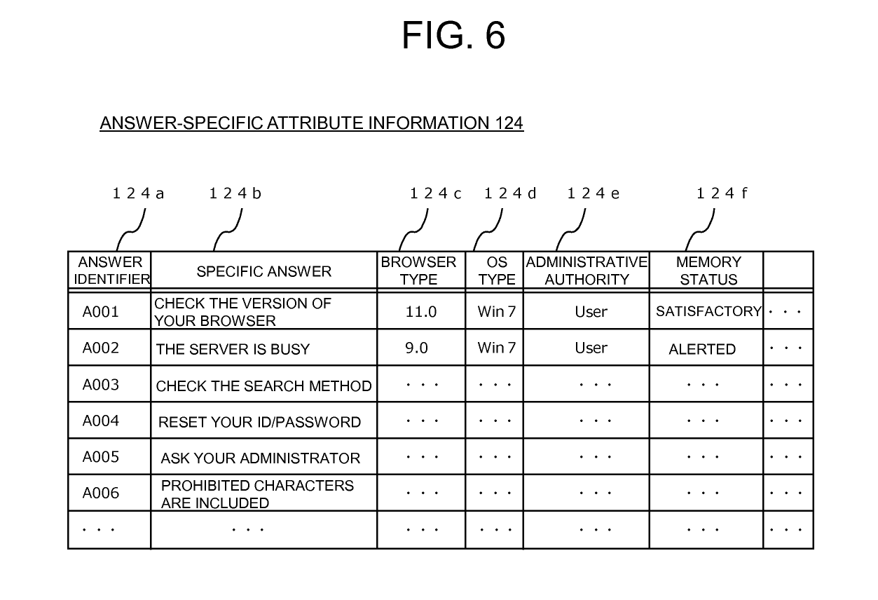

FIG. 6 is a table showing an example of the answer-specific attribute information 124. The answer-specific attribute information 124 is information obtained by associating the answer candidate with the user attribute information on the user expected to be transmitted. The answer-specific attribute information 124 includes an answer identifier 124a, a specific answer 124b, a browser type 124c, an OS type 124d, an administrative authority 124e, and a memory status 124f.

The answer identifier 124a is identification information for identifying the answer candidate. The specific answer 124b is information indicating a specific answer. The browser type 124c is information indicating the type of the browser given to the user against which the answer is suitably transmitted. The OS type 124d is information indicating the type of the OS given to the user. The administrative authority 124e is information indicating the administrative authority of the user.

The memory status 124f is information relating to the use status of the memory of the user terminal 300 used by the user. Note that, as has already been described, the numerical value indicating the usage amount of the memory may be used as the memory status 123e of the user information 123. When the memory status 123e is a numerical value, the memory status 124f of the answer-specific attribute information 124 is information indicating a numerical value having a predetermined range.

The answer-specific attribute information 124 is determined based on, for example, an empirical value. In this case, for example, the answer-specific attribute information 124 may be generated by associating the answer transmitted to the user terminal 300 in the past with the user information 123 on the user, which is a transmission destination.

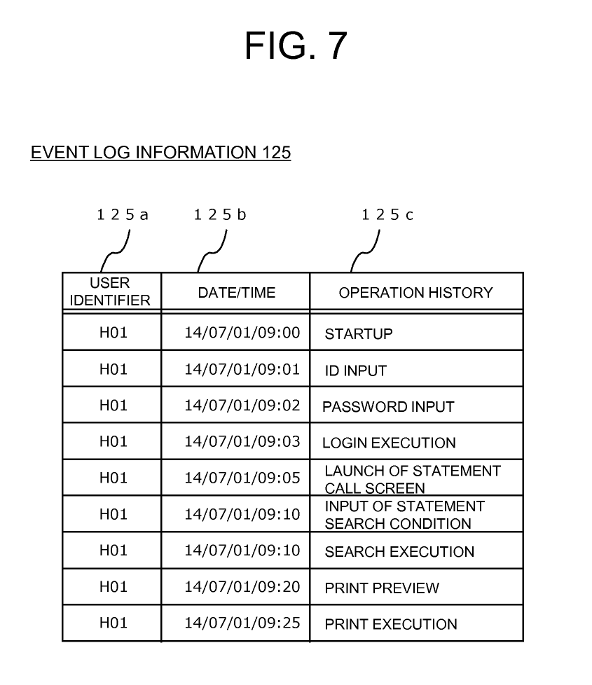

FIG. 7 is a table showing an example of the event log information 125. In the event log information 125, the operation information for the user terminal 300 acquired by the operation information acquisition unit 111 is stored. The event log information 125 includes a user identifier 125a, a date/time 125b, and an operation history 125c.

The user identifier 125a is an identifier for identifying the user. The date/time 125b is a date/time at which the input unit 311 of the user terminal 300 receives the input operation. The operation history 125c is information indicating specific operation information.

For example, the operation information acquisition unit 111 acquires the operation information transmitted from the user terminal 300 operated by the user having the user identifier 125a of “H01”. The operation information acquisition unit 111 determines that the date/time included in the operation information is “14/07/01/09:00” and that the specific operation is “startup”, and generates a record shown on the top of the event log information 125. Subsequently, the operation information acquisition unit 111 acquires the operation information transmitted from the user terminal 300 relating to the same user, and generates a record shown in the second row of the event log information 125 by using “14/07/01/09:01” that is the date/time included in the operation information and “identity (ID) input” that is the specific operation.

Note that, it is desired that the operation history 125c included in the event log information 125 have units that can be compared with the event 121c of the question-specific event log information 121. Therefore, the operation information acquisition unit 111 stores, for example, the operation information on the operation after the selection of the execute button up to the operation information on the operation before the next selection of the execute button, as the operation history 125c. After that, when the operation information acquisition unit 111 acquires another piece of operation information, the information acquisition unit 111 may delete the stored operation history 125c and newly store the operation information as the operation history 125c of the event log information 125.

For example, the event log information 125 shown in FIG. 7 stores the operation information obtained from the startup of the user terminal 300 until the print execution as the operation history 125c.

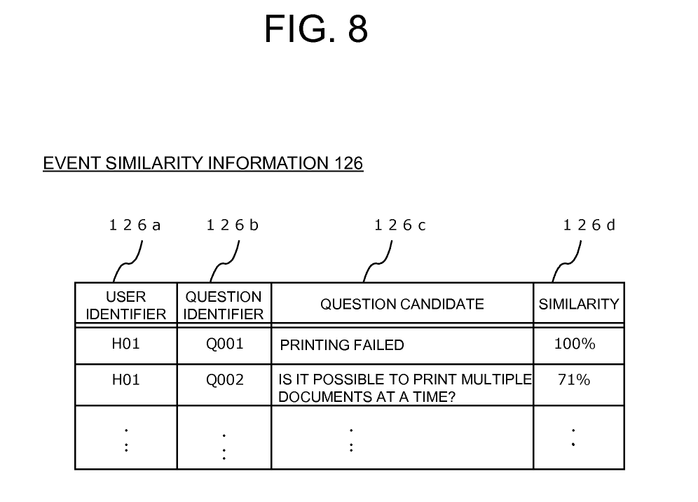

FIG. 8 is a table showing an example of the event similarity information 126. The event similarity information 126 is information obtained by associating the question included in the question-specific event log information 121 with the similarity calculated by the question candidate extraction unit 112. The event similarity information 126 includes a user identifier 126a, a question identifier 126b, a question candidate 126c, and a similarity 126d.

The user identifier 126a is an identifier for identifying the user. The question identifier 126b is an identifier for identifying the question. The question candidate 126c is information indicating a specific question. The similarity 126d is a value of the similarity calculated by the question candidate extraction unit 112 based on a sequence of the event 121c included in the question-specific event log information 121 and a sequence of the operation history 125c included in the event log information 125. The generation of the event similarity information 126 is described later in detail.

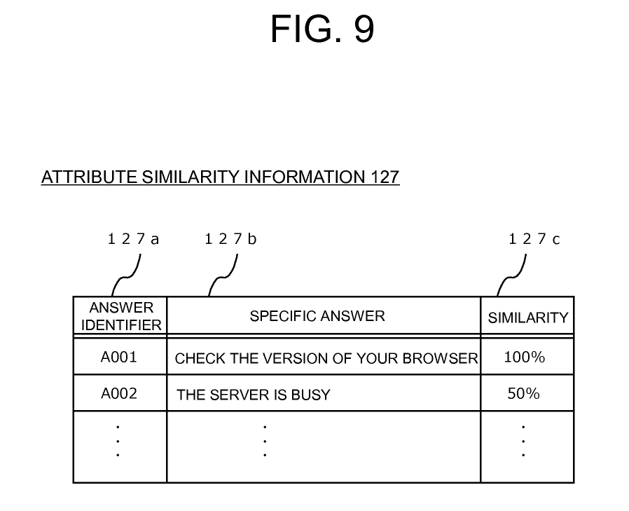

FIG. 9 is a table showing an example of the attribute similarity information 127. The attribute similarity information 127 is information obtained by associating a predetermined answer included in the FAQ master information 122 with the similarity calculated by the answer extraction unit 113. The attribute similarity information 127 includes an answer identifier 127a, a specific answer 127b, and a similarity 127c.

The answer identifier 127a is identification information for identifying the answer candidate. The specific answer 127b is information indicating a specific answer corresponding to the answer candidate. The similarity 127c is a value indicating the similarity calculated for the answer. The generation of the attribute similarity information 127 is described later.

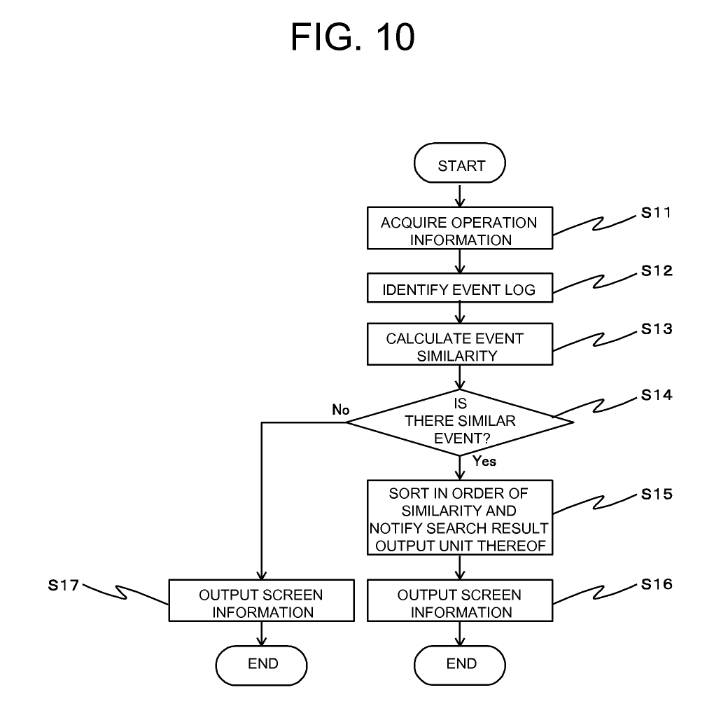

FIG. 10 is a flowchart illustrating a flow of question candidate extraction processing. This processing is started when, for example, the communication unit 115 receives the operation information from the user terminal 300. Note that, this processing may be, for example, periodically performed in the information search/presentation device 100. Further, before the start of this processing, the user terminal 300 acquires the information which identifies the user who operates the user terminal 300, and when the operation information is transmitted from the user terminal 300, the information which identifies the user is transmitted by being added to the operation information to be transmitted.

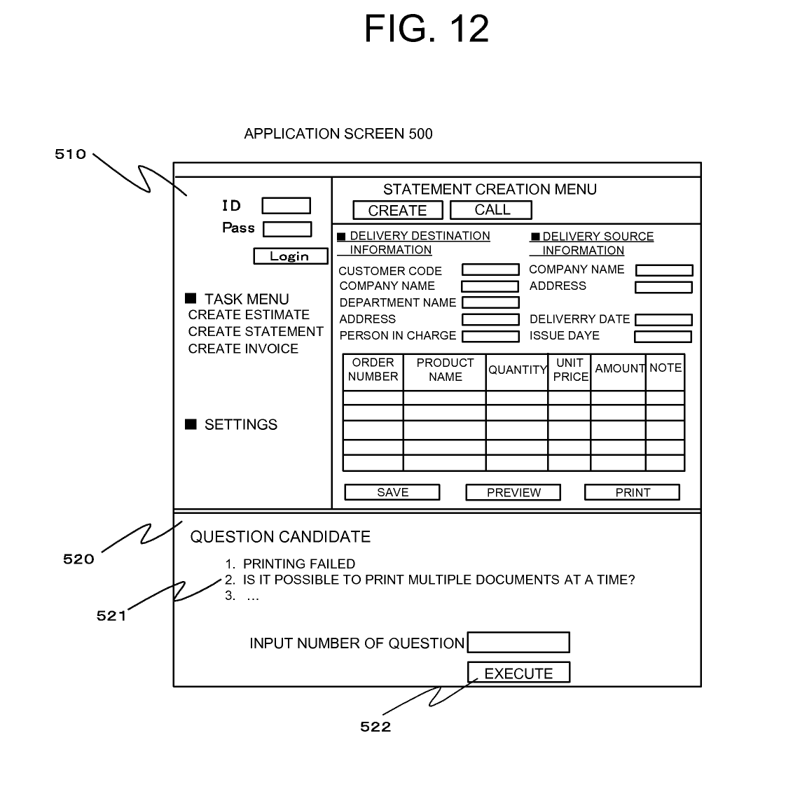

First, the operation information acquisition unit 111 acquires the operation information received by the communication unit 115 (Step S11). The operation information acquisition unit 111 acquires the operation information input to a specific task display area 510 included in an application screen 500 of FIG. 12 described below, which is displayed on the user terminal 300. The operation information includes an operation date/time and information indicating the specific operation, and the information which identifies the user who operates the user terminal 300 is added thereto. The operation information acquisition unit 111 generates a new record in the event log information 125 by using the information indicating the operation date/time and the specific operation.

FIG. 12 is a diagram illustrating an example of the application screen 500 including a question candidate display area 520. The application screen 500 is a screen displayed by the display unit 312 of the user terminal 300. The application screen 500 includes the specific task display area 510 and the question candidate display area 520. In the question candidate display area 520, at least one question candidate 521 and an execute button 522 are displayed. Note that, in Step S11 illustrated in FIG. 10, the question candidate is not extracted, and hence the question candidate 521 is not displayed in the question candidate display area 520.

Further, in this embodiment, the specific task display area 510 and the question candidate display area 520 are displayed within the same application screen 500, but the question candidate display area 520 may be displayed on another separate screen. Further, only when a specific button included in the specific task display area 510 is selected, the question candidate display area 520 may be displayed on the application screen 500.

The description is returned to FIG. 10. Subsequently, the question candidate extraction unit 112 identifies an event log (Step S12). Specifically, the question candidate extraction unit 112 identifies the operation history 125c within the event log information 125 along with the sequence thereof.

Subsequently, the question candidate extraction unit 112 calculates the event similarity (Step S13). Specifically, for each question stored in the question-specific event log information 121, the question candidate extraction unit 112 calculates the similarity based on the sequence of the event 121c associated with the question and the sequence of the operation history identified in Step S12.

Describing by use of the question-specific event log information 121 shown in FIG. 3 and the event log information 125 shown in FIG. 7, “startup”, “ID input”, “password input”, “login execution”, “launch of statement call screen”, “input of statement search condition”, “search execution”, “print preview”, and “print execution” which are the sequence of the operation history 125c of the event log information 125 match the sequence of the specific events 121c associated with the question identifier 121a of “Q001” within the question-specific event log information 121. Accordingly, the question candidate extraction unit 112 sets “100%” as the similarity to the question having the question identifier 121a of “Q001”. Note that, a general method is used for the calculation of the similarity of the sequence, and a detailed description thereof is not made here.

In this manner, the question candidate extraction unit 112 calculates the similarity indicating how much the event log information 125 is similar to the question-specific event log information 121 for each question included in the question-specific event log information 121. The question candidate extraction unit 112 generates a new record in the event similarity information 126 by using a user identifier added to the operation information, a question identifier of the question whose similarity has been calculated, the specific question, and the similarity.

Note that, the calculation of the similarity is not limited to the comparison between the sequences of the operation information. For example, as described below, the similarity may be calculated based on the number of matched pieces of operation information without taking the order of the values included in the sequence into consideration. (i=(question identifier))

(similarity of i)=(number of matched pieces of operation information between the operation history 125c within the event log information 125 and the event 121c relating to i within the question-specific event log information 121)/(number of events 121c relating to i within the question-specific event log information 121).

Subsequently, the question candidate extraction unit 112 determines presence/absence of a similar event (Step S14). Specifically, the question candidate extraction unit 112 determines that there is a similar event (“Yes” in Step S14) when the question whose similarity is not 0% exists in the event similarity information 126. Note that, the question candidate extraction unit 112 may determine that there is a similar event when the event similarity information 126 includes a question having a similarity that exceeds a threshold value stored in an area (not shown) of the storage unit 120.

When the question candidate extraction unit 112 determines that there is a similar event (“Yes” in Step S14), the question candidate extraction unit 112 sorts the similar events in order of the similarity, and notifies the output unit 114 thereof (Step S15). Specifically, the question candidate extraction unit 112 extracts a predetermined number of records from among the records included in the event similarity information 126 in descending order of the similarity, and notifies the output unit 114 of the extracted records as the question candidates. Note that, the predetermined number is stored in advance in the area (not shown) of the storage unit 120. Further, when the number of records included in the event similarity information 126 falls below a predetermined number, the question candidate extraction unit 112 extracts all the records included in the event similarity information 126.

Subsequently, the output unit 114 outputs screen information (Step S16). The output unit 114 generates the display information of the application screen 500 in which the question candidates notified of by the question candidate extraction unit 112 are described in a question candidate display area in descending order of the similarity. The output unit 114 uses the question candidate 126c and the similarity 126d of the event similarity information 126 to generate the display information of the question candidate display area 520. The output unit 114 transmits the generated display information to the user terminal 300 via the communication unit 115. After that, the output unit 114 finishes the processing of this flowchart.

When the question candidate extraction unit 112 does not determine that there is a similar event (“No” in Step S14), the output unit 114 outputs the screen information (Step S17). The output unit 114 generates the display information of the application screen 500 in which information indicating that no question candidate is extracted is described in the question candidate display area, and transmits the generated display information to the user terminal 300. After that, the output unit 114 finishes the processing of this flowchart.

Note that, in this case, the question candidate extraction unit 112 may generate the display information of the application screen 500 so that the question candidate display area displayed before this flowchart is started keeps being displayed.

When the processing of this flowchart is finished, the application screen 500 is displayed on the user terminal 300. This processing is started when the information search/presentation device 100 receives the operation information from the user terminal 300, as a result of which the application screen 500 in which the question candidate display area has been updated is displayed each time input processing is performed on the user terminal 300.

In this embodiment, an appropriate question candidate is extracted based on the operation history of the user, and is displayed on the user terminal 300. When having a question while using the application, the user can refer to the question candidate extracted from the information search/presentation device 100, which eliminates time and labor to make a search for an appropriate question by himself/herself with efficiency.

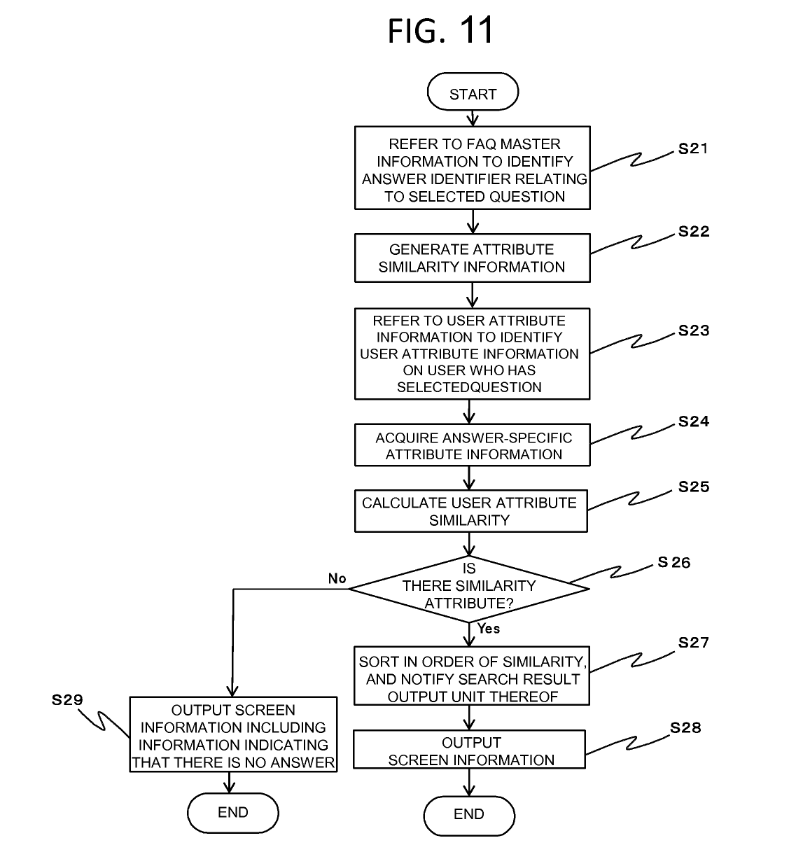

FIG. 11 is a flowchart illustrating a flow of answer extraction processing. This processing is started when the execute button 522 is selected after one question is selected from the question candidates 521 displayed in the question candidate display area 520 of the application screen 500. The communication unit 115 of the information search/presentation device 100 receives the information which identifies the selected question and the information which identifies the user who has transmitted the question from the user terminal 300.

First, the answer extraction unit 113 refers to the FAQ master information 122 to identify the answer identifier 122c relating to the selected question (Step S21). Specifically, the answer extraction unit 113 refers to the information received from the user terminal 300 to identify the question identifier 122a corresponding to the selected question. The answer extraction unit 113 identifies at least one answer identifier 122c and the specific answer 122d which are associated with the identified question identifier 122a.

Subsequently, the answer extraction unit 113 generates the attribute similarity information 127 (Step S22). The answer extraction unit 113 uses the answer identifier identified in Step S21 and the specific answer to generate the attribute similarity information 127. Note that, at this time point, nothing is stored in the similarity 127c of the attribute similarity information 127.

Subsequently, the answer extraction unit 113 refers to the user information 123 to identify the user attribute information on the user who has selected the question (Step S23). The answer extraction unit 113 identifies the user attribute information including, as its items, the user identifier 123a corresponding to the earlier-received information which identifies the user, the associated browser type 123b, the OS type 123c, the administrative authority 123d, and the memory status 123e.

Subsequently, the answer extraction unit 113 acquires the answer-specific attribute information 124 (Step S24). Specifically, for each of at least one answer identifier 122c identified in Step S21, the answer extraction unit 113 acquires the answer-specific attribute information 124 including, as the items of the user attribute information, the browser type 124c relating to the answer identifier 124a corresponding to the answer identifier 122c, the OS type 124d, the administrative authority 124e, and the memory status 124f.

Subsequently, the answer extraction unit 113 calculates a user attribute similarity (Step S25). The answer extraction unit 113 calculates the similarity for each answer identifier by comparing the items of the user attribute information identified in Step S23 with the items of the user attribute information acquired in Step S24. The answer extraction unit 113 stores the calculated similarity in the attribute similarity information 127 for each answer identifier.

For example, it is assumed that the question having the question identifier 122a of “Q001” and the specific question 122b of “Printing failed” within the FAQ master information 122 shown in FIG. 4 is selected on the user terminal 300. In Step S21, as the answer identifiers 122c relating to the question, the answer extraction unit 113 identifies the answer having the answer identifier 122c of “A001”, the answer having the answer identifier 122c of “A002”, and the answer having the answer identifier 122c of “A003”.

Subsequently, the answer extraction unit 113 generates the attribute similarity information 127 in the procedure of Step S22 by using a combination of the answer identifier 122c of “A001” and a specific answer 122d of “Check the version of your browser”, a combination of the answer identifier 122c of “A002” and the specific answer 122d of “The server is busy”, and a combination of the answer identifier 122c of “A003” and the specific answer 122d of “Check the search method”.

Subsequently, in accordance with the procedure of Step S23, the answer extraction unit 113 identifies the user information 123 including the items of the browser type 123b of “11.0”, the OS type 123c of “Win 7”, the administrative authority 123d of “USER”, and the memory status 123e of “satisfactory” from the user information 123 shown in FIG. 5.

Subsequently, the answer extraction unit 113 calculates the similarity for each answer identified by the answer identifier “A001”, “A002”, and “A003”. The similarity is calculated based on the following expression. (j=(answer identifier))

(similarity of j)=(number of matched items between the user attribute information on the user who is operating the user terminal 300 and the user attribute information relating to j within the answer-specific attribute information 124)/(total number of items of the user information 123 relating to j within the answer-specific attribute information 124)

Describing by use of the above-mentioned example, the browser type 123b, the OS type 123c, the administrative authority 123d, and the memory status 123e, which are the items of the user attribute information included in the user information 123 shown in FIG. 5, completely match the browser type 124c, the OS type 124d, the administrative authority 124e, and the memory status 124f, which are the items of the user attribute information included in the user information 123 relating to the answer having the answer identifier 124a of “A001” within the answer-specific attribute information 124 shown in FIG. 6. Accordingly, the answer having the answer identifier of “A001” has the similarity of 100%.

On the other hand, in regard to the answer having the answer identifier of “A002”, the user identification information shown in FIG. 5 and the answer-specific attribute information 124 shown in FIG. 6 match in “Win 7” that is the item of the OS type and “USER” that is the item of the administrative authority, and do not match in the item of the browser type and the item of the memory status. The similarity is 50% with the two matched pairs of items relative to four items in total of the user information 123 relating to the answer identifier “A002” within the answer-specific attribute information 124.

Note that, the calculation of the similarity is not limited to the above-mentioned method. Further, as described above, a numerical value having a predetermined range may be set in the user attribute information included in the answer-specific attribute information 124. In this case, when the numerical value of the item corresponding to the above-mentioned item of the user information 123 falls within the range of the numerical value, the answer extraction unit 113 regards that the information matches in the above-mentioned item.

The description is returned to FIG. 11. Subsequently, the answer extraction unit 113 determines whether or not there is a similarity attribute (Step S26). When the similarity attribute information includes the answer having the similarity other than 0%, the answer extraction unit 113 determines that there is a similarity attribute. Note that, the answer extraction unit 113 may determine that there is a similarity attribute when there is an answer relating to the similarity equal to or larger than the threshold value stored in the storage unit 120 in advance.

When the answer extraction unit 113 determines that there is a similarity attribute (“Yes” in Step S26), the answer extraction unit 113 sorts the answers having the similarity attribute in order of the similarity, and notifies the output unit 114 thereof (Step S27). The answer extraction unit 113 extracts a predetermined number of records from the attribute similarity information 127 in descending order of the similarity, and notifies the output unit 114 of the extracted records as the answers. Note that, the predetermined number is stored in advance in the area (not shown) of the storage unit 120. Note that, when the record included in the attribute similarity information 127 falls below a predetermined number, the answer extraction unit 113 extracts all the records included in the attribute similarity information 127.

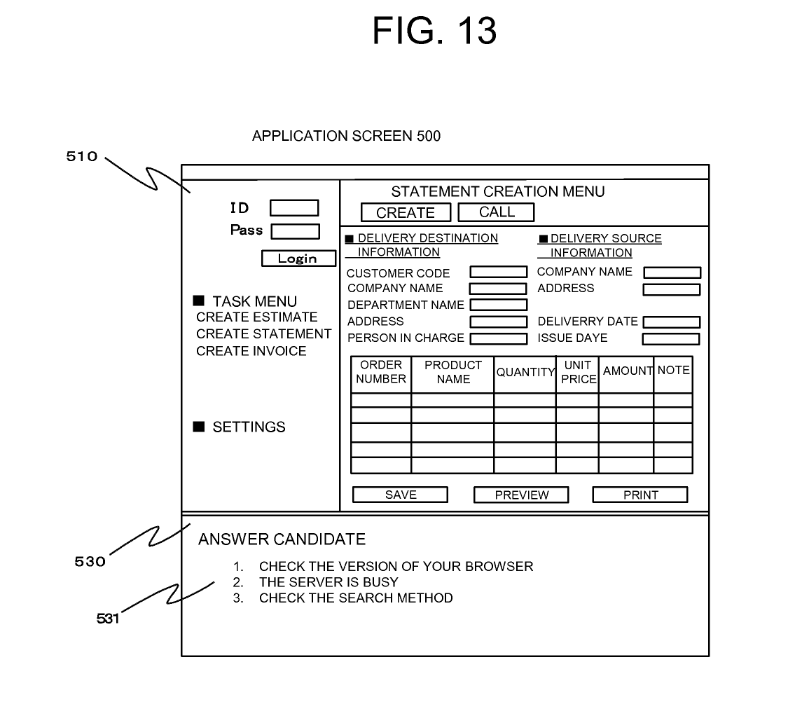

Subsequently, the output unit 114 outputs the screen information (Step S28). The output unit 114 generates the display information of the application screen 500 in which the answers included in the record notified of by the answer extraction unit 113 are included in an answer display area 530 of FIG. 13 described below in descending order of the similarity, and transmits the generated display information to the user terminal 300 via the communication unit 115. After that, the output unit 114 finishes the processing of this flowchart.

FIG. 13 is a diagram illustrating an example of the application screen 500 including the answer display area 530. The application screen 500 includes the answer display area 530 in addition to the specific task display area 510. In the answer display area 530, the answers 531 are displayed in descending order of the similarity. In Step S28 described above, the output unit 114 uses the specific answer 127b included in the similarity attribute information to generate the display information in which the answers are displayed in the answer display area 530 by being sorted in descending order of the similarity.

Note that, on the application screen 500 illustrated in FIG. 13, the answer display area 530 is displayed instead of the question candidate display area 520, but the question candidate display area 520 and the answer display area 530 may be displayed together on the application screen 500.

Note that, in this embodiment, the answer display area 530 and the specific task display area 510 may be displayed on the same application screen 500, or the answer display area 530 may be displayed on another separate screen. However, by displaying the question candidate display area 520 and the answer display area 530 on the same screen as the screen which displays the specific task display area 510, the user can visually recognize the question and the answer while carrying out an operation for the specific task display area 510. Therefore, the user can confirm the question and the answer efficiently without the need to interrupt the operation for the specific task display area 510 in order to launch a FAQ display/input screen.

The description is returned to FIG. 11. When the answer extraction unit 113 does not determine that there is a similarity attribute (“No” in Step S26), the output unit 114 outputs the screen information including information indicating that there is no answer (Step S29). The output unit 114 generates the display information of the application screen 500 in which information indicating that no answer is extracted is described in the answer display area 530, and transmits the generated display information to the user terminal 300. After that, the output unit 114 finishes the processing of this flowchart. Note that, the output unit 114 may generate the display information to be displayed on the application screen 500 so that the display screen displayed before this processing is started keeps being displayed.

According to this embodiment, as the answer to the question, the answer on which the operating environment of the user terminal 300 given to the user is reflected is extracted. By accumulating the appropriate answers presented to the user in the past and the user attribute information on the user in the answer-specific attribute information 124, the appropriate answer can be extracted for the user in accordance with the user attribute information, and can be displayed on the user terminal 300.

Further, in this embodiment, the answer is extracted in accordance with the operating environment of the user terminal 300 given to the user, and hence the appropriate answer can be presented to each user terminal 300 even when, for example, the same user operates different user terminals 300.

### Second Embodiment

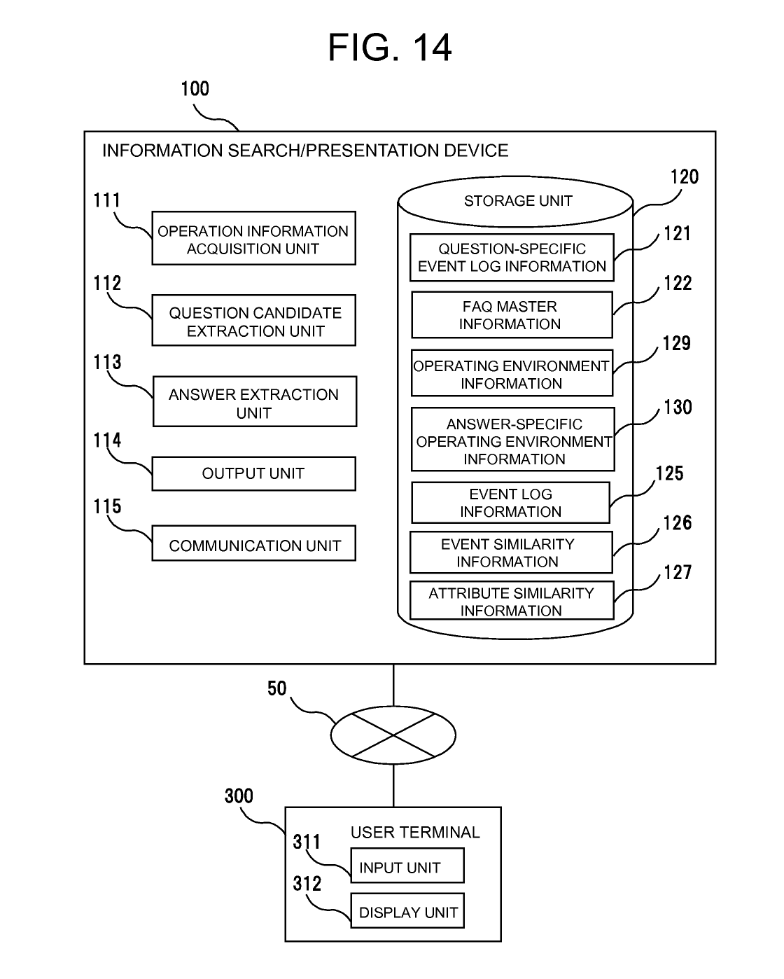

Next, a description is made of a second embodiment of the present invention. FIG. 14 is a diagram illustrating an example of functional blocks of the information search/presentation device 100 according to the second embodiment. Points different from the first embodiment are described below, and descriptions of duplicate points are omitted.

As described above, the information search/presentation device 100 according to the first embodiment functions as a data center in a thin client solution, and the user terminal 300 functions as a thin client terminal. In this embodiment, the program for causing the user terminal 300 to operate is stored within the user terminal 300, and the information relating to the operating environment of the user terminal 300 determined by the program is stored in advance in the information search/presentation device 100. In other words, whoever the user is, the operating environment is determined for each user terminal 300.

The storage unit 120 of the information search/presentation device 100 does not store the user information 123, the answer-specific attribute information 124, or the user-specific terminal information 128, but stores operating environment information 129 and answer-specific operating environment information 130.

The operating environment information 129 is information relating to the operating environment of the user terminal 300, and is associated with, for example, information relating to the OS stored in the user terminal 300, information relating to the browser, information relating to the administrative authority of the user who operates the user terminal 300, and information relating to the memory status of the user terminal 300, for each user terminal identifier which identifies the user terminal 300. In other words, the operating environment information 129 corresponds to the user information 123 according to the first embodiment. Note that, for example, the operating environment information 129 may be acquired by periodically inquiring of the user terminal 300 by the information search/presentation device 100, and may be stored in the storage unit 120, or may be arbitrarily set in advance.

The answer-specific operating environment information 130 is information obtained by associating the answer with the information relating to the operating environment of the user terminal 300 against which the answer is to be suitably transmitted. The answer-specific operating environment information 130 corresponds to the above-mentioned answer-specific attribute information 124.

Note that, in the event log information 125 and the event similarity information 126 according to the first embodiment, the operation history and the question identifier are associated with the user identifier, but in this embodiment, the operation history and the question identifier are associated with the user terminal identifier.

In the question candidate extraction processing according to this embodiment, the operation information acquisition unit 111 acquires the operation information which is transmitted from the user terminal 300 and to which the information identifying the user terminal 300 is added. The operation information acquisition unit 111 generates the event log information 125 by associating the user terminal identifier with information indicating the operation date/time and the specific operation. The question candidate extraction unit 112 calculates the similarity based on the event log information 125 and the question-specific event log information 121 for each question, and questions of a predetermined number or less are extracted in descending order of the similarity. The extracted questions are displayed on the user terminal 300 as the question candidates based on the display information generated by the output unit 114.

In the answer extraction processing, the answer extraction unit 113 calculates the similarity for each answer candidate corresponding to the question selected on the user terminal 300. The similarity is calculated based on a matching degree between the items of the operating environment information 129 and the answer-specific operating environment information 130 on the user terminal 300 which has selected the question. The answer extraction unit 113 extracts answer candidates of a predetermined number or less in descending order of the similarity. The extracted answer candidates are displayed on the user terminal 300 as the answer to the question based on the display information generated by the output unit 114.

According to this embodiment, an appropriate answer to the question asked from the user terminal 300 can be extracted in accordance with the operating environment of the user terminal 300, and can be presented to the user terminal 300. In particular, even when the same user terminal 300 is used by different users, it is possible to obtain the answer corresponding to the user terminal 300.

The respective embodiments and modification examples according to the present invention have been described above, but the present invention is not limited to an example of the above-mentioned embodiments, and includes various modification examples. For example, the examples of the above-mentioned embodiments are described in detail for a better understanding of the present invention, and the present invention is not limited to a configuration including all the components described above. Further, a part of the configuration of an example of a given embodiment can replace the configuration of another example. Further, the configuration of another example can also be added to the configuration of an example of a given embodiment. Further, another configuration can be added to, deleted from, and replaced by a part of the configuration of an example of each of the embodiments. Further, in regard to each of the above-mentioned configurations, functions, processing units, processing means, and the like, a unit thereof or an entirety thereof may be realized by hardware, for example, by being designed as an integrated circuit. Further, the accompanying drawings include control lines and information lines that are assumed to be necessary for the sake of description, but not all thereof are described. It may also be considered that almost all the configurations are connected to one another.

Further, the above-mentioned functional configuration of the above-mentioned information search/presentation device 100 is classified in accordance with main processing contents in order to facilitate the understanding. The present invention is not limited to the classification methods or names of the components. The configuration of the information search/presentation device 100 can also be classified into more components in accordance with the processing contents. Further, the classification may be carried out so that one component executes more kinds of processing.

What is claimed is:

1. An information search/presentation device, comprising:
an operation information acquisition unit configured to acquire a question transmitted from a terminal;
a storage unit configured to store an answer candidate to the question and user attribute information on a user of the terminal to which the answer candidate is expected to be transmitted;
an answer extraction unit configured to calculate a similarity for each answer candidate associated in the storage unit with the question acquired by the operation information acquisition unit, and extract an answer from the answer candidate by using the similarity; and
an output unit configured to output the extracted answer to the terminal,
wherein the answer extraction unit identifies the user attribute information on the user who has transmitted the question, and calculates the similarity between the identified user attribute information and the user attribute information associated with the answer candidate in the storage unit.

2. An information search/presentation device according to claim 1, further comprising a question candidate extraction unit configured to calculate a similarity between an operation history associated with the question in question-specific event log information stored in the storage unit and the operation history of the terminal acquired from the terminal, and extract a question candidate from the question-specific event log information based on the similarity, wherein:
the storage unit stores the question-specific event log information associated with the operation history expected for the question; and
the output unit outputs the question candidate extracted by the question candidate extraction unit to the terminal.

3. An information search/presentation device according to claim 2, wherein the question candidate extraction unit calculates the similarity by using a sequence of the operation history stored in the question-specific event log information and a sequence of the acquired operation history of the terminal.

4. An information search/presentation device according to claim 2, wherein:
the question candidate extraction unit extracts, as the question candidates, the questions of a predetermined number or less having the similarity equal to or larger than a predetermined value in descending order of the similarity; and
the output unit displays the question candidates on the terminal in descending order of the similarity.

5. An information search/presentation device according to claim 1, wherein:
the user attribute information comprises a plurality of items; and
the answer extraction unit calculates the similarity by using a number of items of the user attribute information relating to the user who has transmitted the question, which correspond to the plurality of items of the user attribute information associated with the answer candidate in the storage unit.

6. An information search/presentation device according to claim 1, wherein:
the answer extraction unit extracts, as the answer, the answer candidate having the similarity equal to or larger than a predetermined value; and
the output unit displays the answers on the terminal in descending order of the similarity.

7. An information search/presentation device according to claim 1, wherein the user attribute information comprises information relating to an operating environment of the terminal given to the user.

8. An information search/presentation device according to claim 1, wherein the output unit generates display information used to display an input area for receiving an input operation by the user on the terminal together with an answer display area for displaying the answer, and transmits the display information to the terminal.

9. An information search/presentation method, comprising:
an operation information acquisition procedure of acquiring a question transmitted from a terminal;
an answer extraction procedure of referring to a storage unit configured to store an answer candidate to the question and user attribute information on a user of the terminal to which the answer candidate is expected to be transmitted, calculating a similarity for each answer candidate associated in the storage unit with the question acquired in the operation information acquisition procedure, and extracting an answer from the answer candidate by using the similarity; and
an output procedure of outputting the extracted answer to the terminal,
wherein the answer extraction procedure comprises identifying the user attribute information on the user who has transmitted the question, and calculating the similarity between the identified user attribute information and the user attribute information associated with the answer candidate in the storage unit.
